(19) United States
(12) Patent Application Publication
(10) Pub. No.: US 2013/0009492 A1
(43) Pub. Date: Jan. 10, 2013

(54) DRIVE DEVICE, AND MOVEMENT MECHANISM USING DRIVE DEVICE

(75) Inventors: Shigeki Fujiwara, Osaka (JP); Youhei Ishigami, Osaka (JP); Yoshio Mitsutake, Osaka (JP); Satoshi Suzuki, Osaka (JP)

(73) Assignee: SANYO ELECTRIC CO., LTD., Osaka (JP)

(21) Appl. No.: 13/577,524

(22) PCT Filed: Feb. 16, 2011
(86) PCT No.: PCT/JP2011/053238

§ 371 Date: Sep. 24, 2012

(30) Foreign Application Priority Data
Feb. 16, 2010 (JP) 2010-031838

(51) Int. Cl. H02K 41/02

(52) U.S. Cl. 310/12.06; 310/12.04

(57) ABSTRACT

A drive device includes two integrated electromagnetic coils separated on an axis, an elastic body, and two movable electric conductors. An object-to-be-moved is moved to left with an operation of a left group which includes one electromagnetic coil and one conductor. A first conductor is repulsively moved to right by a repulsion force caused by an eddy current generated on the first conductor with an electrical current-supply to a first electromagnetic coil and then, the elastic body is compressed by the first conductor and subsequently pushes back the first conductor. At this time, the electrical current-supply to the first electromagnetic coil is turned off, and the first conductor collides with the first electromagnetic coil, and this collision generates a leftward impact. The left and right groups enable a left-right reciprocating movement.

### TECHNICAL FIELD

The present invention relates to a drive device using an electromagnetic action and a movement mechanism using the drive device.

### BACKGROUND ART

Conventionally, there is a drive device which repeatedly provides a shock, that is to say, an impact, caused by an electromagnetic action to an object and moves the object. Even the small impact enables the movement of the object when being provided repeatedly, and moreover, it also has an advantage that it enables a high-accuracy position control. There is a known method of using an electrostrictive element or an eddy current to generate the impact (refer to patent documents 1 and 2, for example). The eddy current is a current which circularly flows in a metal plate such as an aluminum plate, for example, when a current flows in an electromagnetic coil which is located close to the metal plate. When an impulse current flows in the electromagnetic coil, a repulsion force which bounces the metal plate off occurs by an interaction between a magnetic field from the electromagnetic coil and the eddy current induced on the metal plate. When the bounced metal plate collides with the object, the impact can be provided to the object via the metal plate. There is a known apparatus which applies such a drive device to a micromanipulator and inserts a fine implement into an ovule using the micromanipulator (refer to patent document 3, for example).

### PRIOR ART DOCUMENT(S)

### Patent Document(s)

Patent Document 1: Japanese Laid-Open Patent Publication No. 60-60582

Patent Document 2: Japanese Patent Publication No. 5-80685

Patent Document 3: Japanese Laid-Open Patent Publication No. 2003-25261

### DISCLOSURE OF THE INVENTION

However, the drive device described in the above patent documents 1 to 3 can only generate the impact in one side (aspect or sense) of a direction using one drive device, and therefore two drive devices are required to reciprocate the object. Thus, a movement mechanism in which an object is reciprocated by such a drive device has problems that a downsizing of the device is restricted and an increased number of the drive devices causes troublesome tasks for parts management and assembly.

The present invention is to solve the above problems, and an object of the present invention is to provide a drive device which can achieve a reciprocating movement and a movement mechanism using the drive device with a compact, simple, and inexpensive configuration.

According to an aspect of the present invention, this object is achieved by a drive device which provides an impact to an object-to-be-moved and moves the object-to-be-moved, the drive device comprises: first and second electromagnetic coils which are separately located on one shaft, placed opposite each other, and integrated with each other so as to be a generation-source of the impact; an elastic body which is located between the first and second electromagnetic coils; a first electric conductor which is located between the first electromagnetic coil and the elastic body; and a second electric conductor which is located between the second electromagnetic coil and the elastic body, wherein the first or second electric conductor can move along an axis direction of the first and second electromagnetic coils at least within an area where the elastic body expands and contracts, and the first or second electric conductor is repulsively moved by a repulsion force caused by an eddy current, which is generated on the first or second electric conductor in accordance with an electrical current-supply to the first or second electromagnetic coil, and then the first or second electric conductor compresses the elastic body, and when the electrical current-supply to the first or second electromagnetic coil is turned off, the first or second electric conductor is pushed back by a stretching force of the elastic body and then collides with the first or second electromagnetic coil, and this collision generates the impact.

In the drive device, one or both of the first and second electric conductors may be replaced with a first or second permanent magnet which is located corresponding to each of the first or second electric conductor, and the replaced first or second permanent magnet may be repulsively moved by an interaction between a coil current flowing in accordance with an electrical current-supply to the first or second electromagnetic coil and a magnetic field of the first or second permanent magnet, instead of the repulsion force caused by the eddy current.

Moreover, in the drive device, the elastic body may be removed, both of the first and second electric conductors may be replaced with the first and second permanent magnets, and the first and second permanent magnets may be located in a direction so that they repel each other, and the repulsion force of the elastic body may be replaced with the electromagnetic repulsion force between the first and second permanent magnets.

According to another aspect of the present invention, the object is achieved by a movement mechanism, comprising: a first moving table; a second moving table which is supported by the first moving table and relatively moves relative to the first moving table; and drive means each of which drives and moves the first and second moving tables, respectively, wherein any of the above drive devices is used as the drive means.

A movement mechanism according to the present invention may comprise: a moving table which moves on a flat surface; and a drive means which drives and moves the moving table, wherein any of the above drive devices may be used as the drive means.

A movement mechanism according to the present invention may comprise: a gimbal structure; and a rotary drive means which rotationally moves a rotatable structure around rotational axis in the gimbal structure, wherein any of the above drive devices may be used as the rotary drive means.

According to the drive device of the present invention, since groups of the electric conductor and the electromagnetic coil are provided each on the both sides of the elastic body, using each of the groups properly, a reciprocating movement of the object-to-be-moved can be achieved by only one drive device. According to the above drive device, a downsized, lightweight, and inexpensive movement mechanism can be achieved. Moreover, since the drive device has the symmetrical configuration in both directions of the reciprocating movement, a symmetrical impact can be generated, and a drive control using the above configuration can easily be achieved.

Moreover, according to the movement mechanism of the present invention, an XY table, a rectilinear movable table, a XYθ table, a gimbal structure which controls an inclination angle, a rotation angle, or the like of a moving object, or the like can be achieved with a compact, simple, and inexpensive configuration without using a motor, a driving force transmission device such as a ball screw, or the like.

### BRIEF DESCRIPTION OF THE DRAWINGS

FIGS. 1A to 1C are partial cross-sectional side views of a drive device according to a first embodiment of the present invention showing an example of its operation in left direction in chronological order according to a first embodiment of the present invention.

FIGS. 2A to 2C are partial cross-sectional side views of the drive device showing an example of its operation in right direction in chronological order.

FIG. 3 is a partial cross-sectional side view of a modification example of the drive device.

FIG. 4A is a pattern diagram for illustrating a principle of operation when a repulsion force is applied in the modification example of FIG. 3, and FIG. 4B is a pattern diagram for illustrating a principle of operation when an attraction force is provided in the modification example of FIG. 3.

FIG. 5 is a partial cross-sectional side view showing another modification example of the drive device.

FIG. 6 is a partial cross-sectional side view showing still another modification example of the drive device.

FIG. 7 is a partial cross-sectional side view showing still another modification example of the drive device.

FIG. 8 is a pattern diagram for illustrating a principle of operation of the modification example.

FIG. 9A to 9C are perspective views showing an example of an operation of a movement mechanism according to a second embodiment.

FIG. 10A is a perspective view showing a modification example of the movement mechanism, and FIG. 10B is a perspective view showing another modification example of the movement mechanism.

FIG. 11 is a perspective view showing still another modification example of the movement mechanism.

FIGS. 12A and 12B are perspective views showing a movement mechanism and an example of an operation according to a third embodiment.

FIG. 13A is a side view showing an example of a rotation movement of the movement mechanism rotating around a Y axis, and FIG. 13B is a side view showing the rotation movement of the movement mechanism viewed from another perpendicular side.

FIG. 14A is a side view showing an example of a rotation movement of the movement mechanism rotating around an X axis, and FIG. 14B is a side view showing the rotation movement of the movement mechanism viewed from another perpendicular side.

FIG. 15 is a partial cross-sectional side view showing still another modification example of the drive device according to the first embodiment of the present invention.

### DESCRIPTION OF THE EMBODIMENT(S)

### First Embodiment

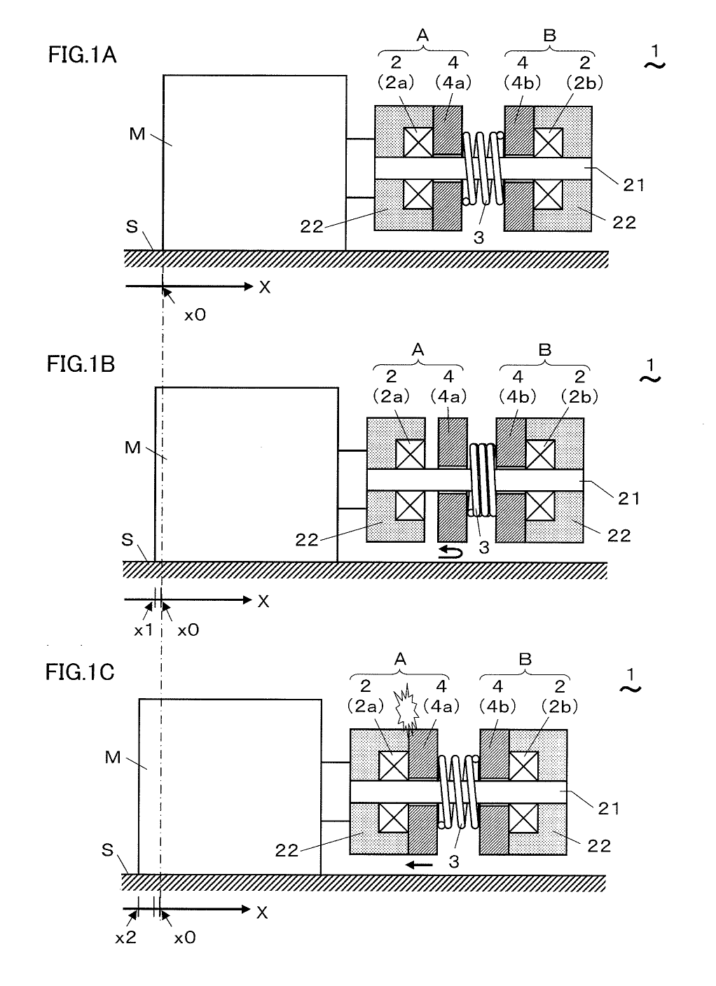

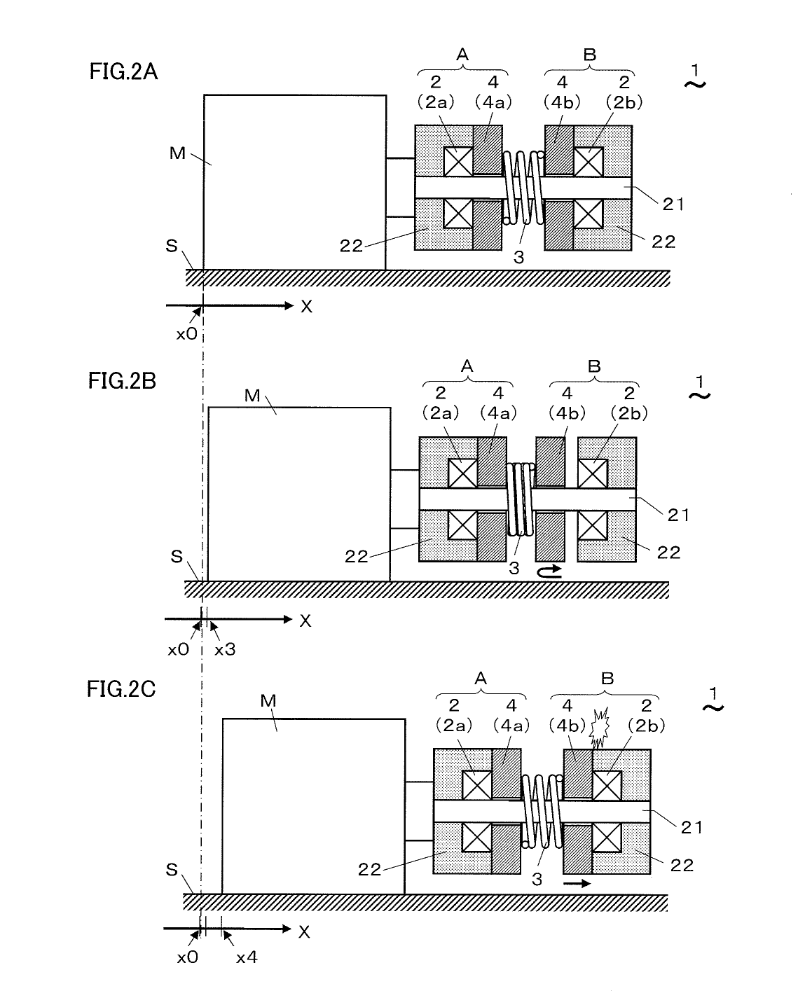

A drive device and a movement mechanism using the drive device according to embodiments of the present invention are described with reference to the drawings. FIGS. 1A, 1B, 1C, 2A, 2B, and 2C show a drive device according to the first embodiment. As shown in FIG. 1A, a drive device 1 includes first and second electromagnetic coils 2a and 2b (also referred to as an electromagnetic coil 2 collectively), an elastic body 3, and first and second electric conductors 4a and 4b (also referred to as an electric conductor 4 collectively) located coaxially each other. The first and second electromagnetic coils 2a and 2b are separately, coaxially and oppositely located each other, and are integrated with each other. The elastic body 3 is located between the first and second electromagnetic coils. The first electric conductor 4a is located between the first electromagnetic coil 2a and the elastic body 3, and the second electric conductor 4b is located between the second electromagnetic coil 2b and the elastic body 3. Each of the first and second electric conductors 4a and 4b is configured to be able to move along an axis direction of the first and second electromagnetic coils 2 at least within an area where the elastic body 3 expands and contracts. The two electromagnetic coils 2 are integrated with each other by an axial rod 21 which is located on a central axis of the electromagnetic coils 2, and placed in respective coil frames 22. The electric conductor 4 is a toroidal metal circular plate made up of a good conductor such as aluminum, for example, and its movement direction is restricted by the axial rod 21. When the drive device 1 is not driven, the elastic body 3 expands so that the electric conductor 4 gets close to the electromagnetic coil 2. The degree of closeness between the electric conductor 4 and the electromagnetic coil 2 is acceptable if the distance is short enough to generate the eddy current on the electric conductor 4, upon driving. The elastic body 3 can be made up of a coil spring or a leaf spring, for example, and can also be made up using rubber or the like. The drive device 1 is provided with groups A and B, each of which has one electromagnetic coil 2 and one electric conductor 4, on both sides of the elastic body 3 along the axial rod 21 so that the groups A and B are located symmetrically and configured symmetrically. In the drawings, an X axis is defined in the direction of the axial rod 21.

An operation of the drive device 1 is described. The drive device 1 provides an impact to an object-to-be-moved M which is located on a friction surface S and moves the object-to-be-moved M in the direction of the axial rod 21 (along X axis direction, and a left-right direction in the drawings). The electromagnetic coil 2, to which electrical current is supplied, is a generation-source of the impact. The object-to-be-moved M is moved to the left in accordance with an operation of the group A located on the left side and moved to the right in accordance with an operation of the group B located on the right side. Firstly, the operation of the group A is described. As shown in FIG. 1B, the first electric conductor 4a is repulsively moved to the right by a repulsion force caused by an eddy current, which is generated on the first electric conductor 4a in accordance with the electrical current-supply to the first electromagnetic coil 2a. Then, the elastic body 3 is compressed by the first electric conductor 4a in moving and subsequently pushes back the first electric conductor 4a by a stretching force. At this time, the electrical current-supply to the first electromagnetic coil 2a is turned off. Thus, as shown in FIG. 1C, the first electric conductor 4a collides with the first electromagnetic coil 2a, and this collision generates a leftward impact. The object-to-be-moved M is pushed and moved to the left by the impact. When a position of the object-to-be-moved M is indicated at its left edge, the object-to-be-moved M is located in a position x0 in FIG. 1A, in a position x1 in FIG. 1B, and in a position x2 in FIG. 1C. The movement between a distance |x0−x1| is caused by recoil generated when the first electric conductor 4a departs from the first electromagnetic coil 2a. The movement between a distance |x1−x2| is caused by recoil generated when the first electric conductor 4a collides with the first electromagnetic coil 2a.

The control of the electrical current-supply to the electromagnetic coil 2 is done to feed the electrical current at once so that the necessary eddy current and the repulsion force caused by it can be obtained and to turn off the electrical current-supply so that the collision of the first electric conductor 4a with the first electromagnetic coil 2a is not disturbed. The impact is repeatedly provided to the object-to-be-moved M by repeating the electrical current-supply under such a control, and thus inching movements of the object-to-be-moved M can be achieved. FIGS. 2A, 2B, and 2C show a movement of the object-to-be-moved M to the right in accordance with an operation of the group B located on the right side. That operation, positions x0, x3, and x4 of the object-to-be-moved M, and so on are similar to those shown in FIGS. 1A, 1B, and 1C.

A function of the friction surface S is described hereinafter. When the drive device 1 is located in free space, the gravity center of itself does not move in accordance with the motion of itself. Moreover, when the drive device 1 is connected to the object-to-be-moved M, the drive device 1 relatively moves together with the object-to-be-moved M relative to a supporting object (the earth, for example) which supports the object-to-be-moved M. In this relative movement, the gravity center of all of the drive device 1, the object-to-be-moved M, and the supporting object does not move. However, irreversibility of the friction force on the friction surface S enables the gravity center of the system composed of the drive device 1 and the object-to-be-moved M, for example, to move relative to the supporting object. In order to exert the irreversibility, it is enough to fulfill conditions, for example, that the impact force generated by the collision of the first electric conductor 4a with the elastic body 3 is smaller than a static friction force on the friction surface S and the impact force generated by the collision with the electromagnetic coil 2a is larger than the static friction force on the friction surface S. The drive device 1 can move the object-to-be-moved M which meets such conditions. The elastic body 3 functions as a damper to reduce the impact by being compressed gradually.

According to the first embodiment, since each of the groups of the electric conductor 4 and the electromagnetic coil 2 is provided on the both sides of the elastic body 3, a reciprocating movement of the object-to-be-moved M can be achieved by only one drive device 1 by selectively and properly using each of the groups A and B. By using the drive device 1, a downsized, lightweight, and inexpensive movement mechanism can be achieved. Moreover, since a symmetrical configuration for both directions of the reciprocating movement can be made and a symmetrical impact can be generated, a drive control for this becomes easy.

### Modification Example of the First Embodiment

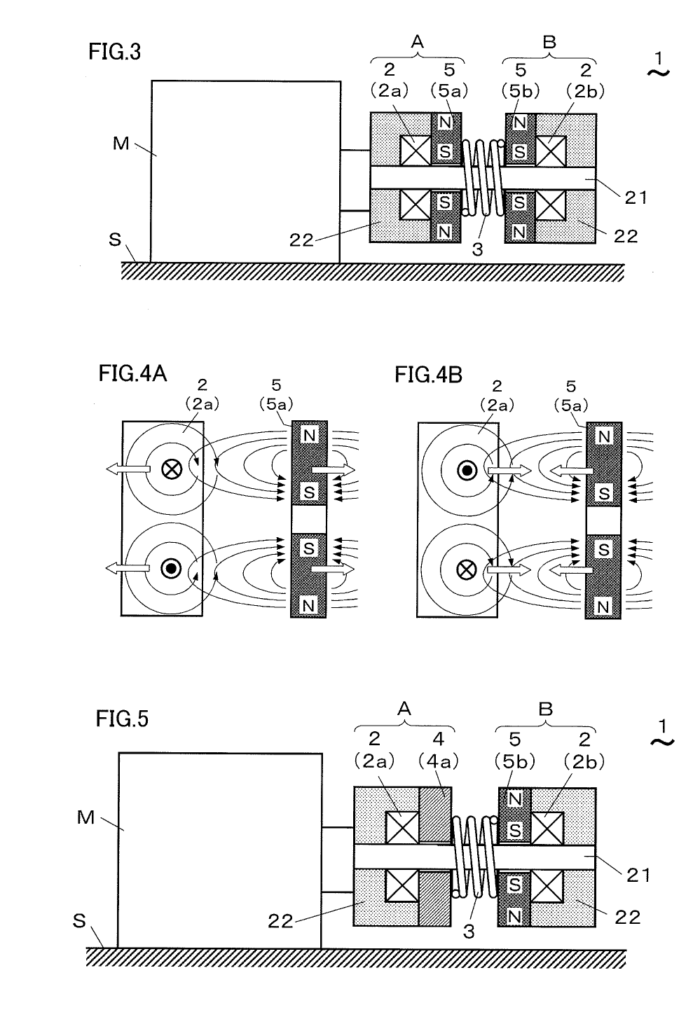

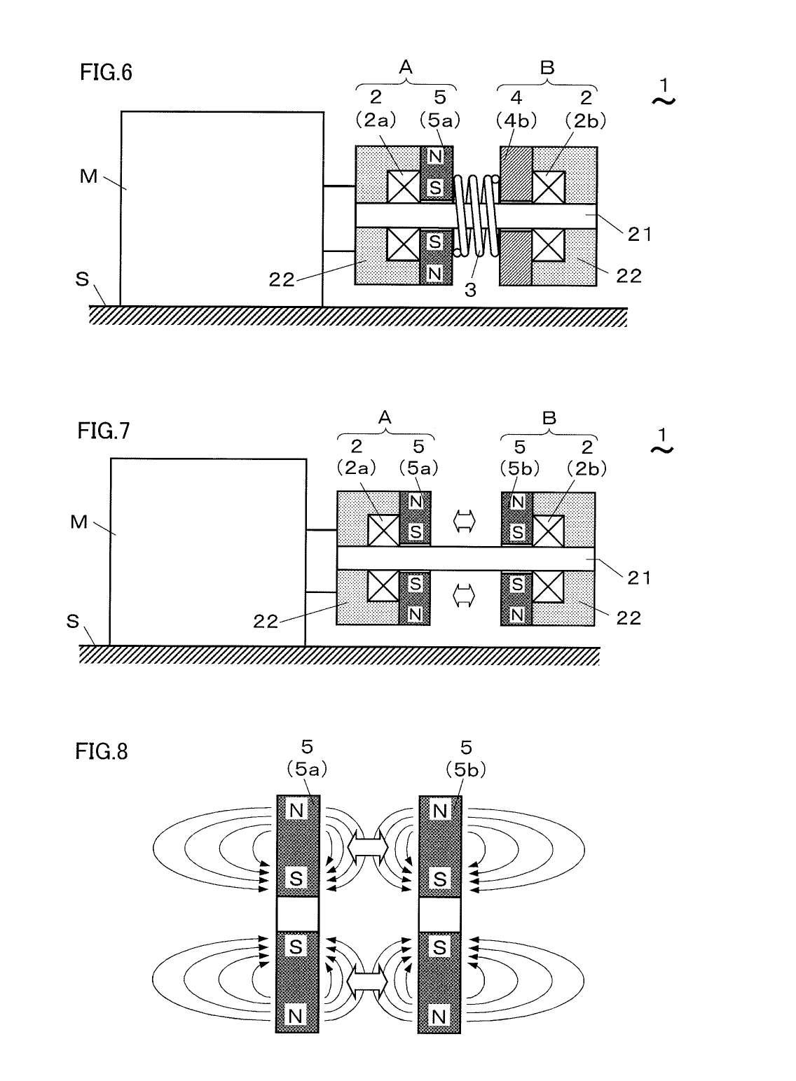

FIGS. 3, 4A, and 4B show a modification example of the drive device according to the first embodiment, and FIGS. 5 and 6 show another modification example of the drive device according to the first embodiment. As shown in FIG. 3, in the drive device 1 of the present modification example, the first and second electric conductors 4a and 4b of the electric conductor 4 in the first embodiment are replaced with first and second permanent magnets 5a and 5b (also referred to as a permanent magnet 5 collectively) which are correspondingly located, respectively. The replaced first or second permanent magnet 5a or 5b is repulsively moved by an interaction between a coil current flowing in accordance with the electrical current-supply to the first or second electromagnetic coil 2a or 2b and a magnetic field of the first or second permanent magnet 5a or 5b. Similar to the electric conductor 4, the permanent magnet 5 has a shape of a toroidal circular plate and is magnetized from a center side toward an outer periphery side in a radial direction. In the present modification example, S pole is located on the center side and N pole is located on the outer periphery side, however, the polarity may be reversed. The above permanent magnet 5 is subject to a repulsion force as shown in FIG. 4A and is subject to an attraction force as shown in FIG. 4B depending on a direction of the electrical current flowing in the electromagnetic coil 2.

An operation of the drive device 1 is described. In the drive device 1, as shown in FIG. 3, when an electrical current is applied to the first electromagnetic coil 2a to provide a repulsion force to the first permanent magnet 5a and subsequently the electrical current is turned off, the first permanent magnet 5a is received by the elastic body 3, and is subsequently recoiled by the elastic body 3 and collides with the first electromagnetic coil 2a. That is to say, in the drive device 1 of the present modification example, the repulsion force generated by an interaction between the coil current flowing in accordance with the electrical current-supply to the electromagnetic coil 2 and the magnetic field of the permanent magnet 5 is used, instead of the repulsion force caused by the eddy current in the above first embodiment 1. The drive device 1 of the present modification example operates similarly to the drive device 1 of the first embodiment. Accordingly, as shown in FIGS. 5 and 6, a combination of the electric conductor 4 and the permanent magnet 5 is also applicable. In the above combination, the operations or the configurations of the groups A and B are not always symmetric. On the contrary, characteristics of the reciprocating movement can be changed by using the asymmetricity, so that a cost or the movement characteristics can be optimized.

According to the present modification example, the repulsion force between the permanent magnet 5 and the electromagnetic coil 2 can be used, so that the larger impact can be generated compared to the impact caused by the eddy current, and the larger movement can be achieved. Moreover, since a heat generation by Joule heat caused by the eddy current does not occur, a stable and an energy-efficient operation can be achieved.

### Still Another Modification Example of the First Embodiment

FIGS. 7 and 8 show a still another modification example of the drive device according to the first embodiment. In a drive device 1 of the present modification example, as shown in FIG. 7, the elastic body 3 in the above first embodiment is removed, both of the first and second electric conductors 4 in the above first embodiment are replaced with the first and second permanent magnets 5, and the first and second permanent magnets 5 are located in a direction so that they repel each other. In other words, in the drive device 1 of the present embodiment, as shown in FIG. 8, the repulsion force of the elastic body 3 is replaced with the electromagnetic repulsion force between the permanent magnets. The configuration of the drive device 1 corresponds to that of the drive device 1 in the above FIG. 3 from which the elastic body 3 is removed, however, a spacing between the groups A and B is appropriately changed. When the first and second permanent magnets 5a and 5b are approaching each other, the impact of the collision is reduced by a damping effect caused by the electromagnetic repulsion force between the permanent magnets. When the first and second permanent magnets 5a and 5b are departing from each other, the permanent magnets 5 which are relatively moving exert the magnetic force on each other, and their moving speed can be continuously accelerated until they collide with the electromagnetic coils 2. Accordingly, as the distance between the groups A and B is increased, the accelerating time becomes longer and the impact force also becomes larger, however, an operating time becomes longer. The distance between the groups A and B is set appropriately in consideration of the above. According to the present modification example, an elastic body such as a spring or the like can be omitted, so that a lightweight and inexpensive drive device can be achieved.

### Second Embodiment

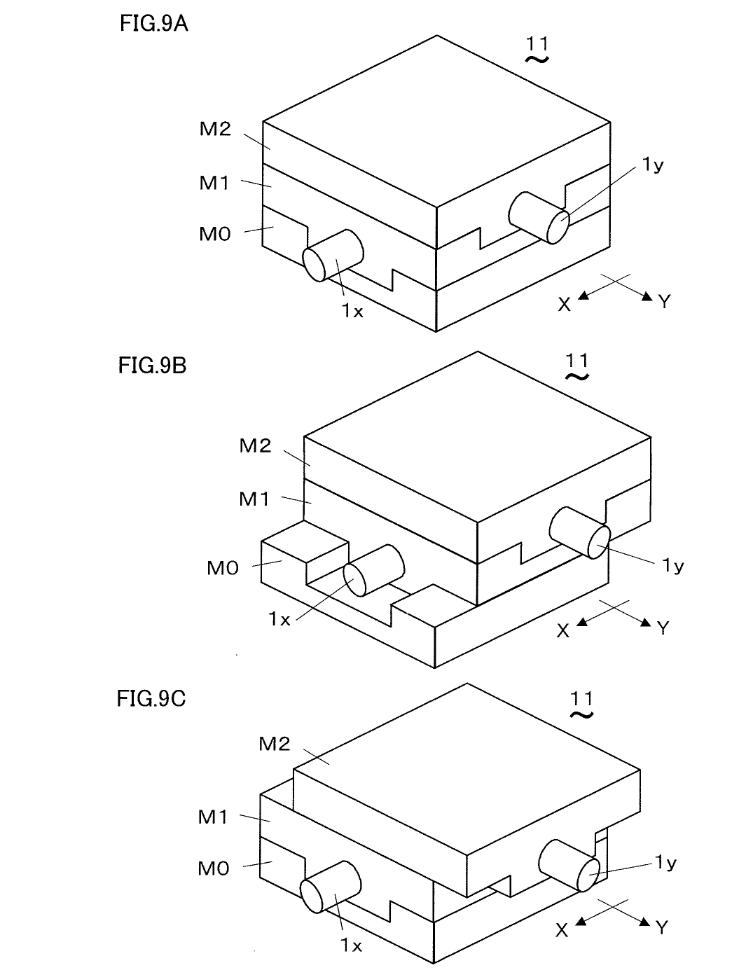

FIGS. 9A to 9C show a movement mechanism according to the second embodiment. As shown in FIG. 9A, a movement mechanism 11 of the present embodiment includes a base table M0, a first moving table M1, a second moving table M2, and drive means 1x and 1y. The first moving table M1 is supported by the base table M0 and is movable along the X axis direction. The second moving table M2 is supported by the moving table M1 and is movable along the Y axis direction perpendicular to the X axis direction. The drive means 1x and 1y drive and move the first and second moving tables M1 and M2, respectively. In the movement mechanism 11, the drive device 1 according to any of the above first embodiment 1 and the modification examples of the first embodiment 1 is used as the drive means 1x and 1y. The movement mechanism 11 is made by putting one linear motion guide on top of another linear motion guide in X and Y directions, respectively, and makes up an XY table.

The support of the first moving tables M1 by the base table M0 and the support of the second moving tables M2 by the first moving table M1 are made via friction surfaces (corresponding to the friction surface S in FIGS. 1A, 1B, and 1C). Accordingly, as shown in FIG. 9B, the whole of the first moving table M1 and the second moving table M2 on the top of the first one is driven in the X axis direction in accordance with the operation of the drive means 1x. Moreover, as shown in FIG. 9C, the second moving table M2 is driven in the Y axis direction in accordance with the operation of the drive means 1y. When the first and second moving tables M1 and M2 are put on each other so that they are driven in the same direction, a movement mechanism of a rectilinearly movable table is achieved. Moreover, a movement mechanism of a rectilinearly movable table can also be achieved by putting only the first moving table M1 without putting the second moving table M2 on the first moving table M1. According to the second embodiment, the XY table or the rectilinearly moving table can be achieved by a compact and simple configuration without using a motor, a driving force transmission device, or the like.

### Modification Example of the Second Embodiment

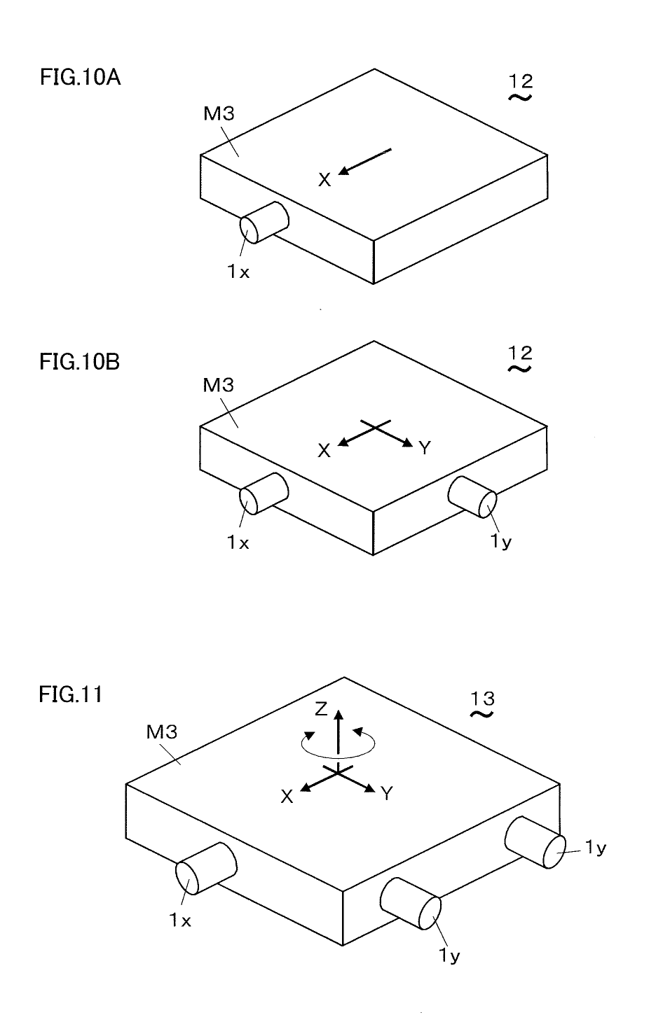

FIGS. 10A, 10B, and 11 show a modification example of the movement mechanism according to the second embodiment. A movement mechanism 12 in FIG. 10A includes a moving table M3 of a flat plate shape used placing on a flat friction surface and a drive means 1x which generates a driving force along an X axis direction parallel to the friction surface. In the movement mechanism 12, the drive device 1 according to any of the above first embodiment 1 and the modification examples of the first embodiment 1 is used as the drive means 1x. Moreover, a movement mechanism 12 in FIG. 10B further includes a drive means 1y which generates a driving force in a Y axis direction parallel to the friction surface and perpendicular to the X axis direction, in addition to the movement mechanism 12 in FIG. 10A. In the same manner as the drive means 1x, the drive device 1 according to any of the above first embodiment 1 and the modification examples of the first embodiment 1 is used as the drive means 1y. The above movement mechanism 12 enables a rectilinear movement or a two-dimensional movement of the moving table M3 on the flat surface by a simple configuration. A movement mechanism 13 in FIG. 11 includes a moving table M3 of a flat plate shape used placing on a friction surface, and drive means 1x and 1y which respectively provide driving forces to the moving table M3 along an X axis direction and a Y axis direction which are parallel to the moving table M3 and perpendicular to each other. In the same manner as the above configuration, the drive device 1 according any of the above first embodiment 1 and the modification examples of the first embodiment 1 is used as the drive means 1x and 1y. The drive means 1x generates the driving force acting on a gravity center of the moving table M3 along the X axis direction and thus enables a reciprocating movement of the moving table M3 along the X axis direction. There are two for the drive means 1y, and lines of action of their driving forces deviate from the gravity center of the moving table M3. Accordingly, when the directions of the driving forces generated the two drive means 1y are opposite to each other in the Y axis direction, the moving table M3 rotates around a Z axis direction perpendicular to the X and Y axes. Moreover, when the directions of the driving forces generated the two drive means 1y are the same with each other and moments of force acting on the moving table M3 are in balance with each other, the moving table M3 is moved along the Y axis direction. Accordingly, when the three drive means 1x, 1y, and 1y are driven, the moving table M3 can be moved in three degrees of freedom, that is to say, the two-dimensional parallel movement in the XY surface and the rotation movement around the Z axis.

Moreover, when the two drive means 1x are provided in parallel with each other in the movement mechanism 12 in FIG. 10A, the two-dimensional movement of the moving table M3 can be achieved by controlling the drive means 1x in a similar manner to a steering of a hand cart by pushing and pulling with both hands of a human. Moreover, when the two drive means 1x are provided on right and left sides of the moving table M3 in the X axis direction, the two drive means 1x can be looked upon as drive wheels on right and left sides of a vehicle, and the two-dimensional movement of the moving table M3 can be achieved by controlling them. Moreover, when a sensor, a control device, and so on for a steering or an autonomous movement are mounted on such a movement mechanism, an autonomous moving device can be achieved. According to the above modification examples, an X table, an XY table, an XYθ table, or the like can easily be achieved with a compact and simple configuration without using a motor, a driving force transmission device, or the like.

### Third Embodiment

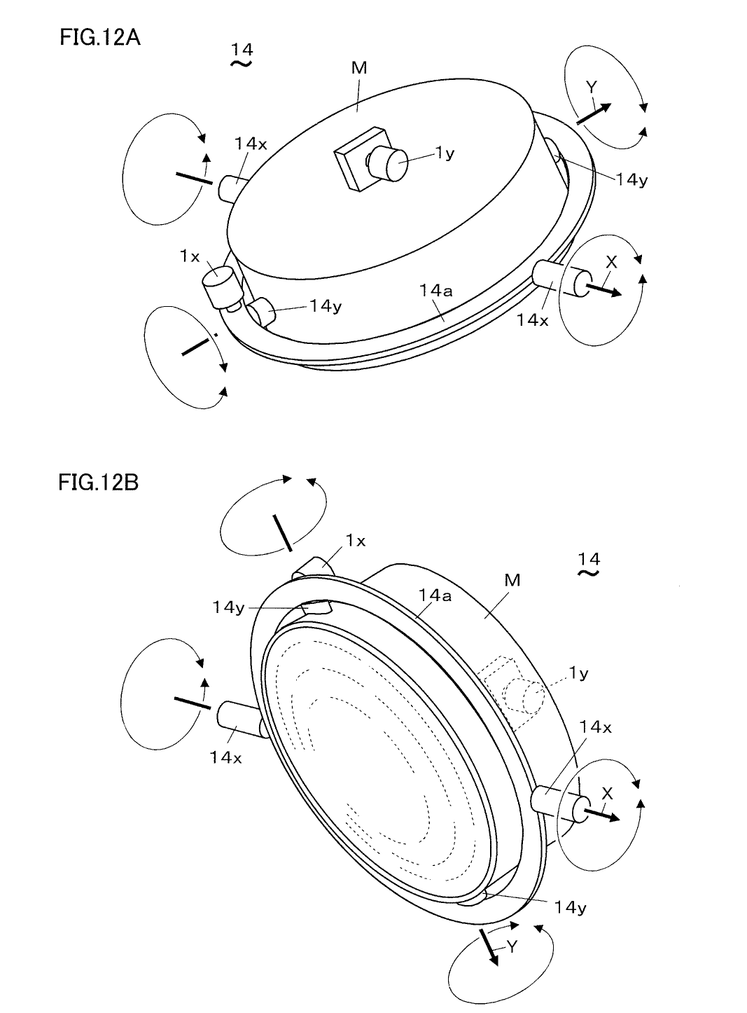

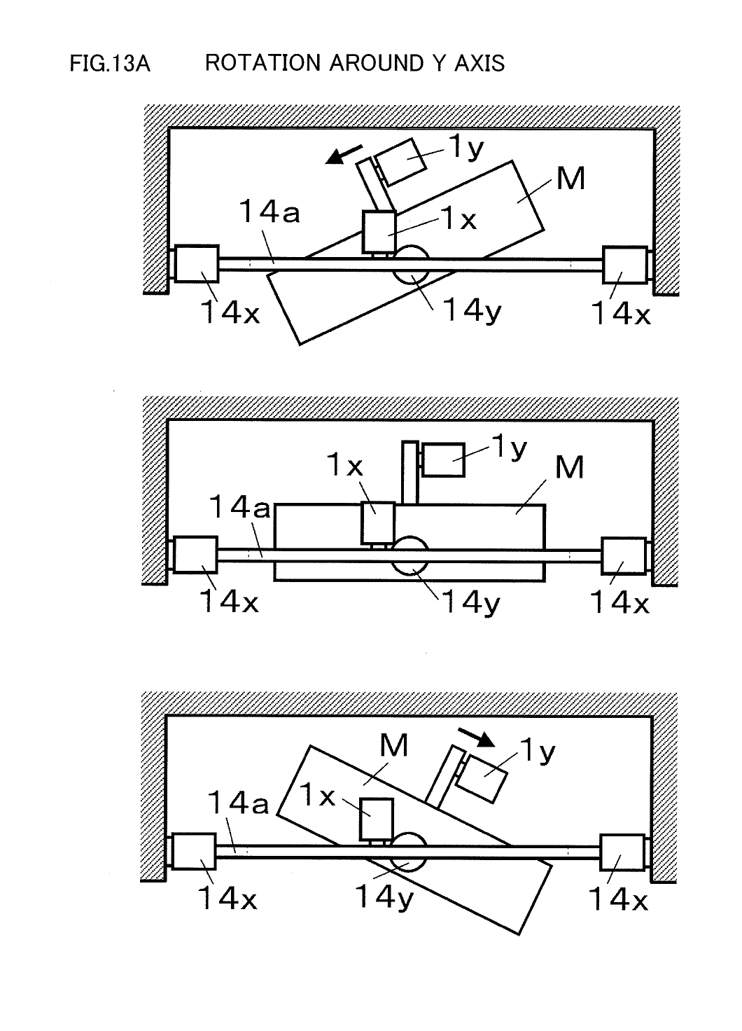

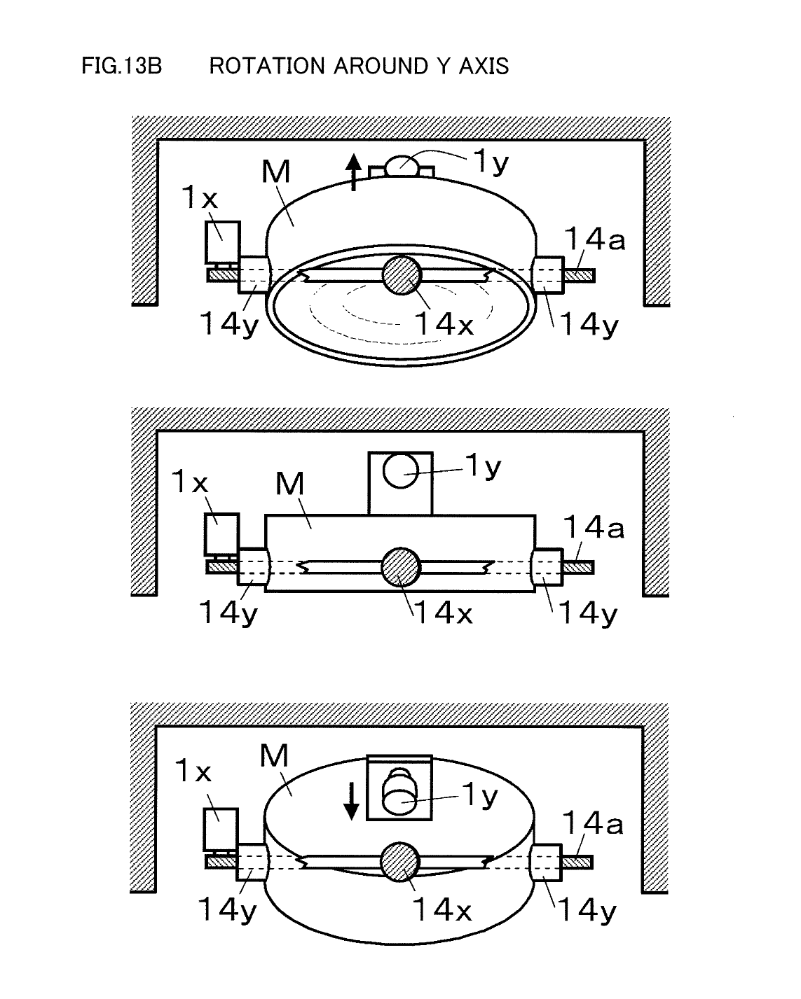

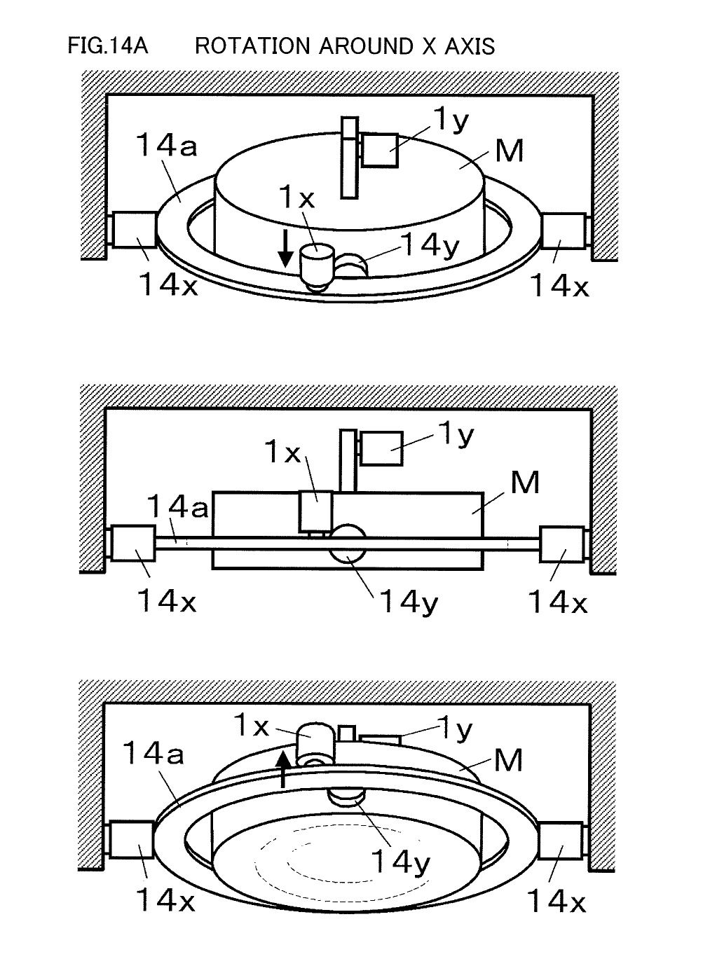

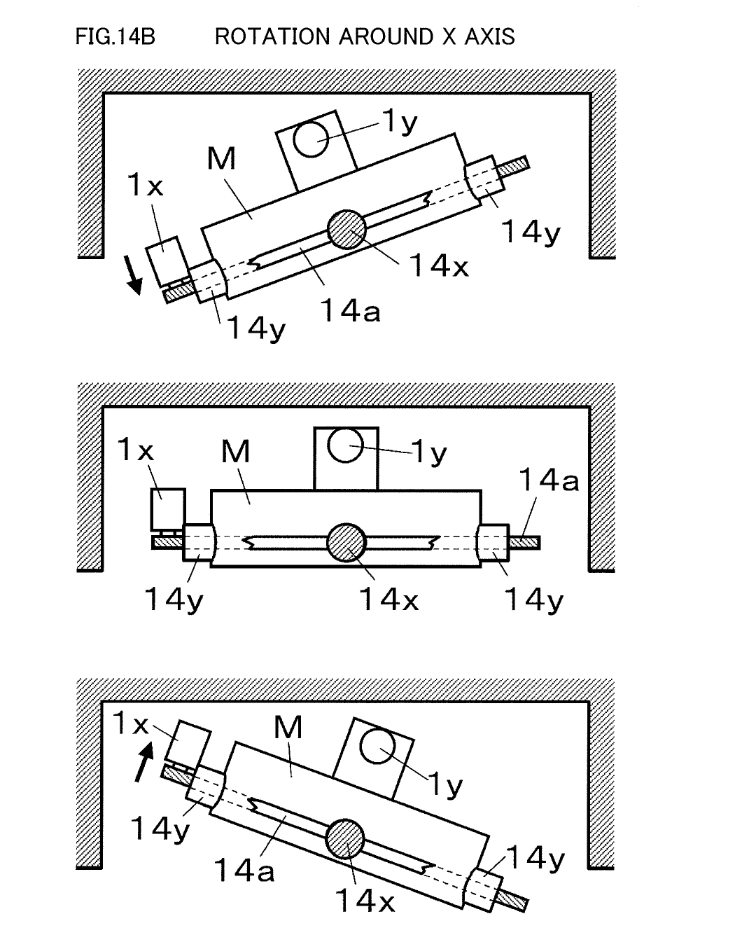

FIGS. 12A, 12B, 13A, 13B, 14A and 14B show a movement mechanism according to the third embodiment. A movement mechanism 14 of the present embodiment rotationally moves an object-to-be-moved M by a gimbal structure and changes a posture of the object-to-be-moved M. As shown in FIGS. 12A and 12B, the movement mechanism 14 includes a circular ring 14a, rotation bearings 14x, rotation bearings 14y, a rotary drive means 1x, and a rotary drive means 1y. The rotation bearings 14x support the circular ring 14a from a stationary side so that the circular ring 14a can rotate around an X axis. The rotation bearings 14y support the object-to-be-moved M so that the object-to-be-moved M can rotate with respect to the circular ring 14a around a Y axis perpendicular to the X axis. The rotary drive means 1x generates a moment of force around the X axis for the circular ring 14a. The rotary drive means 1y generates a moment of force around the Y axis for the object-to-be-moved M. The gimbal structure is configured being provided with the circular ring 14a, the rotation bearings 14x and 14y. The drive device 1 according to any of the above first embodiment 1 and the modification examples of the first embodiment 1 is used as the rotary drive means 1x and 1y. Each of the rotation bearings 14x and 14y is adjusted to generate an appropriate friction force so that the function of the drive device 1 is exerted. Moreover, a ratchet mechanism or the like may also be provided to enable the rotation in each of the rotation bearings 14x and 14y in only one direction without using the friction force. In this case, the rotation can be reversed by reversing a working direction of the ratchet. By setting positions, in which greater moments of force can be generated (positions in which moment arms are longer respectively), as positions of the rotary drive means 1x and 1y, the drive device 1 with a smaller impact force can be used. When the object-to-be-moved M is an illuminating device and is mounted on a wall of a building or a concave portion of a ceiling as shown in FIGS. 13A, 13B, 14A, and 14B, the wall or the concave wall of the ceiling is used as a stationary side, and the object-to-be-moved M (the illuminating device) is mounted by the rotation bearings 14x. FIGS. 13A and 13B show rotary driving around the Y axis, and FIGS. 14A and 14B show rotary driving around the X axis. The inclination control for pan and tilt of the illuminating device can be achieved by operating the rotary drive means 1x and 1y. According to the third embodiment, the movement mechanism which can control the inclination angle, the rotation angle, or the like, of the moving object supported by the gimbal structure can be achieved with a compact and simple configuration without using a motor, a driving force transmission device, or the like.

### Still Another Modification Example of the First Embodiment

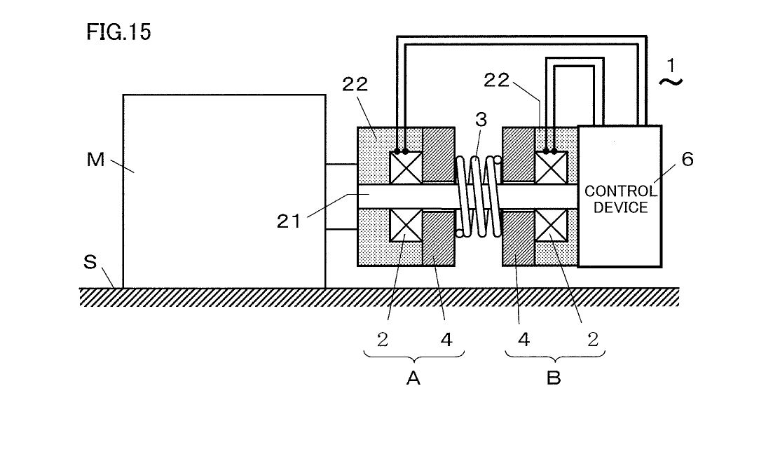

FIG. 15 shows the still another modification example of the drive device according to the first embodiment. The drive device 1 of the present modification example is the one that a control device 6 to control the electrical current supplied to the electromagnetic coils 2 is integrated with a main body of the drive device 1 in the above first embodiment 1. Since the drive device 1 is provided with the control device 6, an easy-to-use drive device and an easy-to-use movement mechanism can be achieved. The control device 6 includes a circuit which temporally controls the electrical current supplied to the electromagnetic coils 2, for example. The control device 6 may also have an electric power source. Moreover, when the control device 6 is provided with a wire communication means or a wireless communication means using infrared light, radio waves, or the like, the drive device 1 and the movement mechanism using the drive device 1 can be remotely controlled. Moreover, in the same manner as the present modification example, a control device which controls the electrical current supplied to the electromagnetic coils 2 may be integrated with a main body of the drive device 1 in the above FIGS. 3 to 8.

The present invention is not limited to the above configurations and can be modified variously. For example, each of the above embodiments and modification examples may be combined with each other. Moreover, in the above configurations, the object-to-be-moved M is described to be supported by the friction surface S, however, the present invention is not limited to such configurations. The drive device 1 may be applied to any object-to-be-moved M, which is under a condition to make the drive device 1 exert its function enough, for example, the one supported under a resistance similar to the friction force in addition to the one supported by the ratchet mechanism or the like. For example, the drive device 1 may be applied to any object-to-be-moved M which is under a resistance from a liquid, a gas, a granulated substance such as sand or grain, a powder substance, or the like.

The present invention is based on Japanese Patent Application No. 2010-31838, and as a result, the subject matter is to be combined with the present invention with reference to the specification and drawings of the above patent application.

### DESCRIPTION OF THE NUMERALS

1, 1x, 1y drive device

2, 2a, 2b electromagnetic coil

3 elastic body

4, 4a, 4b electric conductor

5, 5a, 5b permanent magnet

11, 12, 13, 14 movement mechanism

M object-to-be-moved

M1, M2, M3 moving table

1. A drive device for providing an impact to an object-to-be-moved and moving the object-to-be-moved, comprising:
first and second electromagnetic coils separately located on one shaft, placed opposite each other, and integrated with each other so as to be a generation-source of the impact;
an elastic body located between the first and second electromagnetic coils;
a first electric conductor located between the first electromagnetic coil and the elastic body; and
a second electric conductor located between the second electromagnetic coil and the elastic body, wherein
the first or second electric conductor can move along an axis direction of the first and second electromagnetic coils at least within an area where the elastic body expands and contracts, and
the first or second electric conductor is repulsively moved by a repulsion force caused by an eddy current, generated on the first or second electric conductor in accordance with an electrical current-supply to the first or second electromagnetic coil, and then the first or second electric conductor compresses the elastic body, and when the electrical current-supply to the first or second electromagnetic coil is turned off, the first or second electric conductor is pushed back by a stretching force of the elastic body and then collides with the first or second electromagnetic coil and this collision generates the impact.

2. The drive device according to claim 1, wherein
one or both of the first and second electric conductors are replaced with a first or second permanent magnet which is located corresponding to each of the first or second electric conductor, and
the replaced first or second permanent magnet is repulsively moved by an interaction between a coil current flowing in accordance with an electrical current-supply to the first or second electromagnetic coil and a magnetic field of the first or second permanent magnet, instead of the repulsion force caused by the eddy current.

3. The drive device according to claim 2, wherein
the elastic body is removed,
both of the first and second electric conductors are replaced with the first and second permanent magnets, and
the first and second permanent magnets are located in a direction so that they repel each other, and the repulsion force of the elastic body is replaced with the electromagnetic repulsion force between the first and second permanent magnets.

4. A movement mechanism, comprising:
a first moving table;
a second moving table which is supported by the first moving table and relatively moves relative to the first moving table; and
drive means each of which drives and moves the first and second moving tables, respectively, wherein
the drive device described in claim 1 is used as the drive means.

5. A movement mechanism, comprising:
a moving table which moves on a flat surface; and
a drive means which drives and moves the moving table, wherein
the drive device described in claim 1 is used as the drive means.

6. A movement mechanism, comprising:
a gimbal structure; and
a rotary drive means which rotationally moves a rotatable structure around rotational axis in the gimbal structure, wherein
the drive device described in claim 1 is used as the rotary drive means.

7. A movement mechanism, comprising:
a first moving table;
a second moving table which is supported by the first moving table and relatively moves relative to the first moving table; and
drive means each of which drives and moves the first and second moving tables, respectively, wherein
the drive device described in claim 2 is used as the drive means

8. A movement mechanism, comprising:
a first moving table;
a second moving table which is supported by the first moving table and relatively moves relative to the first moving table; and
drive means each of which drives and moves the first and second moving tables, respectively, wherein
the drive device described in claim 3 is used as the drive means

9. A movement mechanism, comprising:
a moving table which moves on a flat surface; and
a drive means which drives and moves the moving table, wherein
the drive device described in claim 2 is used as the drive means.

10. A movement mechanism, comprising:
a moving table which moves on a flat surface; and
a drive means which drives and moves the moving table, wherein
the drive device described in claim 3 is used as the drive means.

11. A movement mechanism, comprising:
a gimbal structure; and
a rotary drive means which rotationally moves a rotatable structure around rotational axis in the gimbal structure, wherein
the drive device described in claim 2 is used as the rotary drive means.

12. A movement mechanism, comprising:
a gimbal structure; and
a rotary drive means which rotationally moves a rotatable structure around rotational axis in the gimbal structure, wherein
the drive device described in claim 3 is used as the rotary drive means.
